(19) United States
(12) Patent Application Publication
(10) Pub. No.: US 2006/0215881 A1
(43) Pub. Date: Sep. 28, 2006

(54) Distance measurement apparatus, electronic device, distance measurement method, distance measurement control program and computer-readable recording medium

(75) Inventors: Tatsushi Nakajima, Nara (JP); Shunsuke Nagasawa, Kyoto (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/371,159

(22) Filed: Mar. 9, 2006

(30) Foreign Application Priority Data
Mar. 23, 2005 (JP) 2005-84940

(51) Int. Cl. G06K 9/00

(52) U.S. Cl. 382/106

(57) ABSTRACT

A distance measurement apparatus includes comprising: an image capturing section for capturing an image of an object to be imaged, for which information is known regarding an image capturing position, an angle of image capturing direction and an image capturing area; a reference image storage section for receiving the image from the image capturing section and storing an image information of the image as a reference image; and a distance data computation section for determining a distance data L, the distance data L indicating a distance between the object to be imaged and the image capturing position, the determination being based on a lowermost position information of the object to be imaged in an image frame, the lowermost position information being based on a difference value between the image information of the reference image stored in the reference image storage section and an image information of an image newly captured by the image capturing section.

This Nonprovisional application claims priority under 35 U.S.C. §119(a) on Patent Applications No. 2005-84940 filed in Japan on Mar. 23, 2005, the entire contents of which are hereby incorporated by reference.

### BACKGROUND OF THE INVENTION

1. Field of the Invention

The present invention relates to: a distance measurement apparatus capable of determining a distance from the apparatus to an object to be imaged and a size of the object to be imaged (the height from ground surface). The distance and size are determined based on an image. The size of the image varies depending on the distance to be imaged from the apparatus. The present invention also relates to; an electronic device (e.g. a vacuum clear running randomly in a room or a surveillance camera) having the distance measurement apparatus mounted thereon; a distance measurement method using the distance measurement apparatus; a distance measurement control program for causing a computer to execute each step of the distance measurement method; and a computer-readable medium for having the distance measurement control program recorded thereon.

2. Description of the Related Art

As a conventional example, the most common distance measurement apparatus used to determine a distance by making use of a captured image is, for example, disclosed in Reference 1. In this conventional technique, two or more image capturing apparatuses are mounted on a vehicle. Each corresponding image information of images simultaneously captured by the image capturing apparatuses is compared to each other. By using the triangular surveying method, the distance from the image capturing apparatuses to the object to be imaged is determined (detected) based on the difference of coordinates between each corresponding image information of the two images with the same image pattern.

Reference 2 discloses an apparatus which determines (detects) the distance to an object to be imaged using one camera (not two cameras provided as image capturing apparatuses in a stereoscopic arrangement). In this conventional technique, an object whose distance between each corner point is known is imaged using one camera. Thereafter, coordinate values in an image information of an image are obtained for three or more corner points. Based on the obtained coordinate values and a distance between each known corner point and the focal distance of camera, the height from the ground surface to the camera and the angle between the camera and the ground surface are calculated using, for example, the least squares method. Thereafter, by using the calculated values, a distance from the camera to an arbitrary object is calculated based on the coordinate values in the image information of the image.
[Reference 1] Japanese Laid-Open Publication No. 06-266828
[Reference 2] Japanese Laid-Open Publication No. 07-120258

### SUMMARY OF THE INVENTION

As disclosed in Reference 1, there are the following problems (1) to (3) when a distance is determined using the triangular surveying method, etc.

(1) Due to the necessity of two or more image capturing apparatuses, there is a problem of increasing the cost of the distance measurement apparatus.

(2) It is necessary to match the timing of capturing images between each image capturing apparatus. It is also necessary to match the timing between each image capturing apparatus in processing moving images. If the matching of timing between each image capturing apparatus is not sufficiently performed, there is a problem that the accuracy of computation decreases.

(3) A large amount of computation is required to calculate the coordinates corresponding to each other among a plurality of image information of images obtained by each image capturing apparatus. When a coordinate in one image information with one image pattern is shifted (moved), little by little, with respect to the other image information in order to find the corresponding coordinate, it is necessary, for example, to perform the N×N number of comparisons in order to find the correspondence between a pixel in one image information with N pixels and the pixel corresponding thereto in the other image information with N pixels. Thus, for an entire image, it is necessary to perform the N×N×N number of comparisons. Therefore, there is a problem that the processing speed is decreased or the cost required for a computation unit which performs with an improved processing speed is increased.

The method disclosed in Reference 2 requires an object to be imaged whose size is known. When there is no presence of such an object, the measurement of distance cannot be performed.

The present invention is made to solve the problems described above. The objective of the present invention is to provide: a distance measurement apparatus capable of determining (detecting) a distance between an object to be imaged and an image capturing apparatus by performing a simple image processing without requiring two or more image capturing apparatuses or without the necessity to know the size of the object to be imaged; an electronic device (e.g. a vacuum clear running randomly in a room or a surveillance camera) having the distance measurement apparatus mounted thereon; a distance measurement method using the distance measurement apparatus; a distance measurement control program for causing a computer to execute each step of the distance measurement method; and a computer-readable medium for having the distance measurement control program recorded thereon.

A distance measurement apparatus according to the present invention includes: an image capturing section for capturing an image of an object to be imaged, for which information is known regarding an image capturing position, an angle of image capturing direction and an image capturing area; a reference image storage section for receiving the image from the image capturing section and storing an image information of the image as a reference image; and a distance data computation section for determining a distance data L, the distance data L indicating a distance between the object to be imaged and the image capturing position, the determination being based on a lowermost position information of the object to be imaged in an image frame, the lowermost position information being based on a difference value between the image information of the reference image stored in the reference image storage section and an image information of an image newly captured by the image capturing section, thereby the objective described above being achieved.

Furthermore, a distance data computation section in a distance measurement apparatus according to the present invention includes: after the completion of the process of storing the reference image by the reference image storage section, a difference image summing section for adding an absolute value of difference between each corresponding image information of the two images for each of a plurality of lines and outputting a total amount of pixel data for each line, using the image information of the reference image stored in the reference image storage section and the image information of the image newly captured by the image capturing section as input images; a first line computation section for receiving a total amount of pixel data for each of a total number of lines y in the image frame obtained by the difference image summing section, and identifying a maximum line No. Y1 as the lowermost position information among each and every one of the respective total amounts of pixel data for each line received, the maximum line No. Y1 having a value greater than or equal to an object determination threshold; and a distance data obtaining section for obtaining a distance data L indicating a distance between the object to be imaged on the ground and the image capturing position, the obtaining being based on the maximum line No. Y1 identified by the first line computation section.

A distance measurement apparatus according to the present invention includes: an image capturing section for capturing an image of an object to be imaged, for which information is known regarding an image capturing position, an angle of image capturing direction and an image capturing area; after the completion of the process of storing the reference image by the reference image storage section, a difference image summing section for adding an absolute value of difference between each corresponding image information of the two images for each of a plurality of lines and outputting a total amount of pixel data for each line, using the image information of the reference image stored in the reference image storage section and the image information of the image newly captured by the image capturing section as input images; a first line computation section for receiving a total amount of pixel data for each of a total number of lines y in the image frame obtained by the difference image summing section, and identifying a maximum line No. Y1 as the lowermost position information among each and every one of the respective total amounts of pixel data for each line received, the maximum line No. Y1 having a value greater than or equal to an object determination threshold; and a distance data obtaining section for obtaining a distance data L indicating a distance between the object to be imaged on the ground and the image capturing position, the obtaining being based on the maximum line No. Y1 identified by the first line computation section, thereby the objective described above being achieved.

Preferably, in a distance measurement apparatus according to the present invention, the information of the image capturing position is a height H from the ground surface to the image capturing section, the information of the angle of the image capturing direction is an angle θ2 between a line normal to a light receiving plane of the image capturing section and the ground surface, and the information of the image capturing area is a viewing angle θ1 in the longitudinal direction of the image capturing section, and an angle θ4 between the direction of an uppermost angle of the viewing angle θ1 and the ground surface.

Furthermore, preferably, in a distance measurement apparatus according to the present invention, the distance data obtaining section calculates the distance data L using the equation:
L=H÷(tan (Y1×θ1÷y+θ4))
(where θ1 is a viewing angle in the longitudinal direction of the image capturing apparatus and θ4 is a viewing angle between the direction of uppermost angle of the viewing angle θ1 and the ground surface in a horizontal direction).

Furthermore, preferably, in a distance measurement apparatus according to the present invention, the distance data obtaining section is configured by a distance table memory in which the maximum line No. Y1 and the distance data L are associated with each other, and wherein the distance data obtaining section uses the maximum line No. Y1 as an address for the distance table memory and outputs the distance data L corresponding to the address.

Furthermore, preferably, in a distance measurement apparatus according to the present invention the distance table L is previously calculated and registered in the distance table memory so as to correspond to the maximum line No. Y1, the distance table L being calculated using the equation:
L=H÷(tan (Y1×θ1÷y+θ4))
(where θ1 is a viewing angle in the longitudinal direction of the image capturing apparatus and θ4 is a viewing angle between the direction of uppermost angle of the viewing angle θ1 and the ground surface in a horizontal direction).

Furthermore, preferably, in a distance measurement apparatus according to the present invention, the distance data computation section further includes: a second line computation section for receiving a total amount of pixel data for each of total number of lines y in an image frame from the difference image summing section, and identifying, among each and every one of the respective total amounts of pixel data for each line received, a minimum line No. Y2 as an uppermost position information of the object to be imaged in the image frame, the minimum line No. Y2 having a value greater than or equal to an object determination threshold; and a height data obtaining section for obtaining a height data indicating a height from the ground surface to the top of an object to be imaged using the maximum line No. Y1 and the minimum line No. Y2.

Furthermore, preferably, in a distance measurement apparatus according to the present invention the height data obtaining section calculates the height data h using the equation:
h=H−L×tan ((Y1−Y2)÷y×θ1+θ4)
(where θ1 is a viewing angle in the longitudinal direction of the image capturing apparatus and θ4 is a viewing angle between the direction of uppermost angle of the viewing angle θ1 and the ground surface in a horizontal direction).

Furthermore, preferably, in a distance measurement apparatus according to the present invention, the height data obtaining section is configured by a height table memory in which the maximum line No. Y1, the difference between the maximum line No. Y1 and the minimum line No. Y2 (maximum line No. Y1−the minimum line No. Y2) and the height data h are associated with each other, and wherein the height data obtaining section uses the maximum line No. Y1 and the difference between the maximum line No. Y1 and the minimum line No. Y2 (maximum line No. Y1−the minimum line No. Y2) as an address for the height table memory and outputs the height data h corresponding to the address.

Furthermore, preferably, in a distance measurement apparatus according to the present invention, the height data h is previously calculated and registered in the height table memory so as to correspond to the maximum line No. Y1 and the difference between the maximum line No. Y1 and the minimum line No. Y2 (maximum line No. Y1−the minimum line No. Y2), the height data h being calculated using the equation:
h=H−L×tan ((Y1−Y2)÷y×θ1+θ4)
(where θ1 is a viewing angle in the longitudinal direction of the image capturing apparatus and θ4 is a viewing angle between the direction of uppermost angle of the viewing angle θ1 and the ground surface in a horizontal direction).

Furthermore, preferably, in a distance measurement apparatus according to the present invention, the difference image summing section outputs a total amount of pixel data for each of a total number of lines y in an image frame, using the image information of the reference image stored in the reference image storage section and the image information of the image newly captured by the image capturing section as input images when the absolute value of difference between each corresponding image information of the two images which is less than the object determination threshold is “0” and the absolute value of difference between each corresponding image information of the two images which is greater than or equal to the object determination threshold is “1”.

An electronic device according to the present invention, having the aforementioned distance measurement apparatus according to the present invention mounted thereon, for performing a risk avoidance processing when the distance between the distance measurement apparatus and an object to be imaged obtained by the distance measurement apparatus is within a predetermined range.

A distance measurement method according to the present invention includes: after the completion of the process of storing a reference image by a reference image storage section which stores an image information of an image from the image capturing section as the reference image, for which information is known regarding an image capturing position, an angle of image capturing direction and an image capturing area, a distance data computation step of determining a distance data L, the distance data L indicating a distance between the object to be imaged and the image capturing position, the determination is based on a lowermost position information of the object to be imaged in an image frame, the lowermost position information being based on a difference value between the image information of the reference image stored in the reference image storage section and an image information of an image newly captured by the image capturing section, thereby the objective described above being achieved.

Preferably, in a distance measurement method according to the present invention, a distance data computation step includes: a difference image summing step of adding an absolute value of difference between each corresponding image information of the two images for each of a plurality of lines and outputting a total amount of pixel data for each line, the summing step using the image information of the reference image stored in the reference image storage section and the image information of the image newly captured by the image capturing section as input images; a first line computation step of receiving a total amount of pixel data for each of a total number of line y in an image frame obtained from the difference image summing step, and identifying a maximum line No. Y1 as a lowermost position information among each and every one of the respective total amounts of pixel data for each line received, the maximum line No. Y1 having a value greater than or equal to an object determination threshold; and a distance data obtaining step of obtaining a distance data L, the distance data L indicating a distance between the object to be imaged on the ground and the image capturing position, the distance data obtaining step being based on the maximum line No. Y1 identified from the first line computation step.

Furthermore, preferably, in a distance measurement method according to the present invention, the distance data computation step further includes: a second line computation step of receiving a total amount of pixel data for each of a total number of lines y in an image frame obtained from the difference image summing step, and identifying, among each and every one of the respective total amounts of pixel data for each line received, a minimum line No. Y2 as an uppermost position information of the object to be imaged in the image frame, the minimum line No. Y2 having a value greater than or equal to an object determination threshold; and a height data obtaining step of determining a height from the ground surface to the top of an object to be imaged using the maximum line No. Y1 and the minimum line No. Y2.

A distance measurement method according to the present invention includes: after the completion of the process of storing a reference image by a reference image storage section which stores an image information of an image from the image capturing section as the reference image, for which information is known regarding an image capturing position, an angle of image capturing direction and an image capturing area, a difference image summing step of adding an absolute value of difference between each corresponding image information of the two images for each of a plurality of lines and outputting a total amount of pixel data for each line, the summing step using the image information of the reference image stored in the reference image storage section and the image information of the image newly captured by the image capturing section as input images; a first line computation step of receiving a total amount of pixel data for each of a total number of line y in an image frame obtained from the difference image summing step, and identifying a maximum line No. Y1 among each and every one of the respective total amounts of pixel data for each line received, the maximum line No. Y1 having a value greater than or equal to an object determination threshold; and a distance data obtaining step of obtaining a distance data L, the distance data L indicating a distance between the object to be imaged on the ground and the image capturing position, the distance data obtaining step being based on the maximum line No. Y1 identified from the first line computation step, thereby the objective described above being achieved.

A distance measurement control program according to the present invention causes a computer to execute each step of the distance measurement method according to the present invention, thereby the objective described above being achieved.

A computer-readable medium according to the present invention is a computer medium having the aforementioned distance measurement control program according to the present invention recorded thereon, thereby the objective described above being achieved.

Hereinafter, the effect of the present invention having the structure described above will be described.

In the present invention, a reference image is captured by an image capturing section, for which information is known regarding an image capturing position, an angle of image capturing direction and an image capturing area. The reference image is stored in a reference image storage section. An object A to be imaged is imaged by the image capturing section. A distance data L indicating the distance between the object to be imaged and the image capturing position is determined based on a lowermost position information of the object to be imaged in an image frame, the lowermost position information being based on the difference value between the image information of the reference image stored in the reference image storage apparatus and the image information of the image newly captured by the image capturing apparatus.

For example, the absolute value of difference which is this difference value is added for each line in the image information by a difference image summing apparatus. A total amount of pixel data for each line is output from the difference image summing apparatus. A maximum line No. Y1 among each and every one of the respective total amounts of pixel data for each of y number of lines in an image frame (y is the total number of lines in the image frame) is calculated by a first line computation section. The maximum line No. Y1 has a value greater than or equal to the object determination threshold. When it is assumed that the ground surface is flat and the object A to be imaged is on the ground, it is possible to calculate a distance data L, which indicates a distance between the object A to be imaged and the image capturing position by a distance calculation section based on the maximum line No. Y1 since it is considered that the maximum line No. Y1 is the coordinate at the foot of the object A to be imaged. Although the calculation of the distance data L is performed by a computation processing, it is possible to perform the processing more easily and rapidly by using a distance table memory in which the maximum line No. Y1 and the distance data L information are associated with each other.

By calculating a minimum line No. Y2, having a value greater than or equal to the object determination threshold using a second line computation section, among each and every one of the respective total amounts of pixel data for each of y number of lines in the image frame (y is the total number of lines in the image frame) from the difference image summing section, it is possible to calculate a height data h which indicates a height from the ground surface to the top of the object A to be imaged by a height data calculation section, based on the maximum line No. Y1 and the difference between the maximum line No. Y1 and the minimum line No. Y2 (maximum line No. Y1−the minimum line No. Y2). Although the calculation of the height data h is performed by a computation processing, it is possible to perform the processing more easily and rapidly by using a height table memory in which the maximum line No. Y1, the difference between the maximum line No. Y1 and the minimum line No. Y2 (maximum line No. Y1−the minimum line No. Y2) and the height data h information are associated with each other.

Furthermore, in the difference image summing section, when it is assumed that the absolute value of difference between each corresponding image information of the two images which is less than the object determination threshold is “0” and the absolute value of difference of the two images between each corresponding image information which is greater than or equal to the object determination threshold is “1”, it is possible to obtain the distance data L and/or the height data h based on a total amount of pixel data added for each line by obtaining the maximum line No. Y1 and the minimum line No. Y2 having a value greater than or equal to the object determination threshold.

As described above, according to the present invention, it is possible to detect a distance between an object to be imaged and an image capturing position and the height from the ground surface to the top of the object A to be imaged by performing a simple image processing. As a result, the processing speed is improved. Furthermore, there is no need for two or more image capturing apparatuses as required by the conventional method or no need for matching the timing of capturing images between each image capturing apparatus. Thus, it is possible to prevent a decrease in computation accuracy. Furthermore, only one image capturing apparatus is required and there is no need for a computation unit to perform high speed processing. Thus, the cost of the apparatus can be reduced.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a structure of a distance measurement apparatus according to Embodiment 1 of the present invention.

FIG. 2 is a schematic diagram showing a mounting environment of the distance measurement apparatus in FIG. 1.

FIGS. 3(a) to (f) are diagrams for explaining the relationship between an object to be imaged and a captured image captured by the distance measurement apparatus in FIG. 1.

FIG. 4 is a diagram showing a structural example of a distance table memory in FIG. 1.

FIG. 5 is a block diagram showing a structure of a distance measurement apparatus according to Embodiment 2 of the present invention.

FIG. 6 is a diagram showing a structural example of a height table memory shown in FIG. 5.

FIG. 7 is a block diagram showing a structure of a distance measurement apparatus according to Embodiment 3 of the present invention.

FIG. 8 is a flowchart showing an example of operation of the distance measurement apparatus in FIG. 7.

### DESCRIPTION OF THE PREFERRED EMBODIMENTS

Hereinafter, Embodiments 1 to 3 of distance measurement apparatuses according to the present invention will be described in detail with reference to the accompanying drawings.

### Embodiment 1

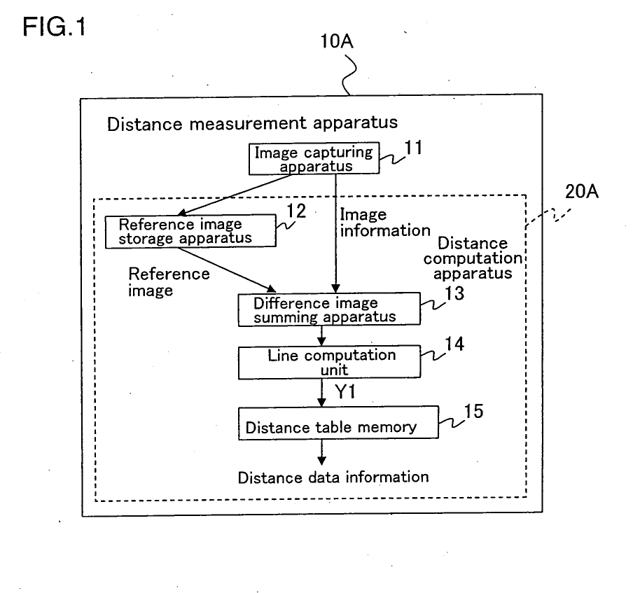

FIG. 1 is a block diagram showing a structure of a distance measurement apparatus according to Embodiment 1 of the present invention. Arrows shown in FIG. 1 indicate a flow pattern of data, and the processing involved.

In FIG. 1, a distance measurement apparatus 10A includes an image capturing apparatus 11 which functions as an image capturing section, a reference image storage apparatus 12 which functions as a reference image storage section, a difference image summing apparatus 13 which functions as a difference image summing section, a first line computation unit 14 which functions as a first line computation section and a distance table memory 15 which functions as a distance data obtaining section. A distance computation apparatus 20A is configured by the reference image storage section 12, the difference image summing apparatus 13, the first line computation unit 14 and the distance table memory 15. Referring to the distance computation apparatus 20A, a distance data computation section is configured by the difference image summing apparatus 13, the first line computation unit 14 and the distance table memory 15. A distance data L indicating a distance between an object A to be imaged and an image capturing position is obtained based on a lowermost position information (maximum line No. Y1) of the object A to be imaged in an image frame, the lowermost position information being based on a difference value (absolute value of difference; the subtraction result when the value of the image information of a reference image is subtracted from the value of the image information of a newly captured image) between an image information of a reference image stored in the reference image storage apparatus 12 and an image information of an image newly captured by the image capturing apparatus 11.

The image capturing apparatus 11 captures an image with a two-dimensional (height and width; not depth) image information. A CCD camera or a CMOS camera is cited as an example of an image capturing apparatus. The image capturing apparatus, as described later, is arranged such that the image capturing position (mounting position of the image capturing apparatus 11), the angle of image capturing direction and the image capturing area are known.

The reference image storage apparatus 12 is configured by an image memory which stores an image information of an image, from the image capturing apparatus 11, as a reference image. The reference image storage apparatus 12 stores, for example, the first image from the image capturing apparatus 11 as a reference image. However, depending on image capturing conditions of the image capturing apparatus 11, the second or later image can be stored as a reference image.

The difference image summing apparatus 13 calculates the absolute value of difference between each corresponding image information of two input images and adds the absolute value of difference between each corresponding image information of the two images for each line of the image information of the two image sand outputs a total amount of pixel data for each line. Among the two input images, one of them is the image information of the reference image stored in the reference image storage apparatus 12 and the other is an image information of an image newly captured by the image capturing apparatus 11. The difference image summing apparatus 13 operates after the completion of the process of storing the reference image by the reference image storage apparatus 12 and performs a difference image summing processing between the image information of the reference image and the image information of the image captured after the reference image which is stored in the reference image storage apparatus 12.

The first line computation unit 14 receives a total amount of pixel data for each of y number of lines in an image frame (y is the total number of lines in the image frame) from the difference image summing section 13, the total amount of pixel data relating to a y coordinate, and outputs a maximum line No. Y1 among each and every one of the respective total amounts of pixel data for each line received. The maximum line No. Y1 has a value greater than or equal to the object determination threshold. Herein, one line data is a cluster of data containing an absolute value of difference relating to the same y coordinate.

The distance table memory 15 calculates a distance data L which indicates a distance between the object A to be imaged on the ground and the image capturing position (mounting position of the image capturing apparatus 11) based on the maximum line No. Y1 output from the first line computation unit 14. In Embodiment 1, the maximum line No. Y1 is used as an address for the distance table memory 15, and the distance data L corresponding to the maximum line No. Y1 is output by accessing the distance table memory 15. The distance data L is registered in the distance table memory 15.

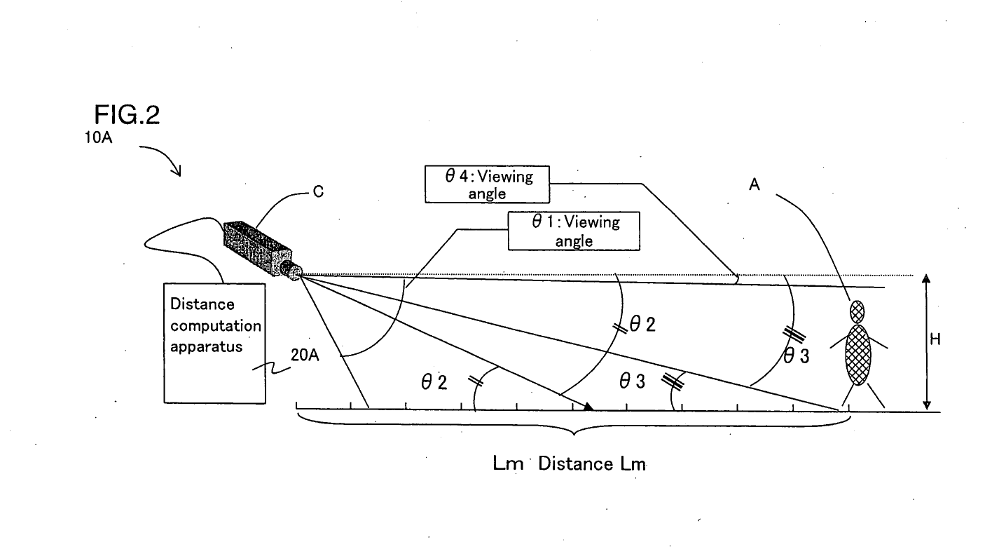

FIG. 2 is a schematic diagram for explaining the mounting environment of the distance measurement apparatus 10A according to Embodiment 1.

In FIG. 2, the object A to be imaged is an object whose distance is to be obtained. In FIG. 2, the object A to be imaged is a human. However, the object A to be imaged is not limited to the human.

A CCD camera or a CMOS camera is cited as a camera C of the image capturing apparatus 11. However, as long as the image capturing apparatus 11 can provide an image with a two dimensional (height and width; not depth) image information to the reference image storage apparatus 12 and the difference image summing apparatus 13, any image capturing apparatus can be used as the camera C.

θ1 shows a viewing angle in a longitudinal direction of the image capturing apparatus 11 (image capturing area).

θ2 is an angle between a line normal to a light receiving plane of the image capturing apparatus 11 and the ground surface in a horizontal direction. Usually, θ2 is an angle between the direction of light axis of the lens of the camera C and the ground surface in a horizontal direction.

θ3 is an angle between the ground surface and a line connecting the camera C to the foot of an object A (human, etc) to be imaged. The distance table memory 15 obtains the distance L to the object A to be imaged based on the y coordinate Y1 at which the image having 93 is positioned in the image information.

θ4 is a viewing angle between the direction of uppermost angle of the viewing angle θ1 and the ground surface in a horizontal direction.

H is a height from the ground surface to the mounting position of the image capturing apparatus 11.

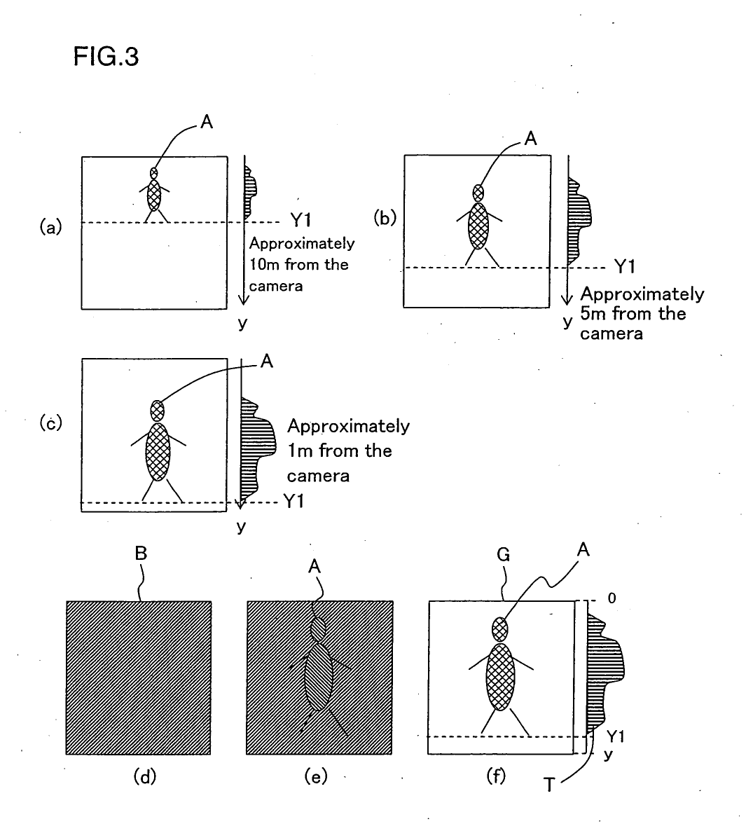

FIG. 3 is a schematic diagram showing the relationship between the object A to be imaged and a captured image in FIG. 2. FIGS. 3(a) to 3(c) show that the foot position of the object A to be imaged is different in each image information, depending on the distance between the object A to be imaged and the image capturing apparatus 11, even if the same object A to be imaged is imaged.

FIGS. 3(a) to 3(c) show how a y coordinate Y1 at the foot of the object A to be imaged changes when the distance between the image capturing apparatus 11 and the object A to be imaged is made shorter in the order of approximately 10 m, approximately 5 m and approximately 1 m, respectively, from the image capturing apparatus 11 (camera C). Each graph shown on the right side in FIGS. 3(a) to 3(c) shows the distribution of total amount of the absolute value of difference of pixel data between each respective image information of the reference image and each respective image of the captured image which corresponds, for each of the lines.

FIG. 3(d) shows a reference image B. First, an image information of an image which does not include the object A to be imaged is stored as a reference image in the reference image storage apparatus 12.

FIG. 3(e) shows an image input from the image capturing apparatus 11 which includes the object A to be imaged.

FIG. 3(f) shows a difference image data G for which an absolute value of difference between each corresponding image information of the reference image and the image input from the image capturing apparatus 11 is calculated. Herein, the difference image data G (X, Y) shows the result of the sum of the difference of a total amount of pixel data for each line, the difference being between each corresponding coordinate (where the X is a coordinate in a horizontal direction and the Y is a coordinate in a vertical direction). A graph shown on the right side in FIG. 3(f) shows the distribution of a total amount of pixel data (projection data T) containing the absolute value of difference between the reference image and the input image for each line. Herein, the projection data T (Y) is sampled for each line (Y) with the difference image data G (X, Y) as input.

As shown in FIGS. 3(a) to 3(c), when the object A to be imaged is the same size in each instance, a lowermost coordinate (indicated by a broken line) of the object A to be imaged changes depending on the distance between the image capturing apparatus 11 and the object A to be imaged. Herein, it is assumed that the ground surface is flat and the object A to be imaged is on the ground surface. Therefore, Y1 is a coordinate (maximum line number as a lowermost position information of an object A to be imaged in an image frame) at the foot of the object A to be imaged. The relationship between the coordinate Y1 (the maximum line No. Y1) and the distance L is expressed using the following equation (6).

Information of the image capturing position is the height H from the ground surface to the image capturing apparatus 11. Angle information of the image capturing direction is the angle θ2 between a line normal to the light receiving plane of the image capturing apparatus 11 and the ground surface in a horizontal direction. Information of the image capturing area is the angle θ4 between the direction of uppermost angle of the viewing angle θ1 in a longitudinal direction of the image capturing apparatus 11 and the ground surface, and the width y of the image information in a longitudinal direction. When the image capturing position, the angle of the image capturing direction, the image capturing area and the width y of the image information are known, it is assumed that the coordinate at the foot of the object A to be imaged in the image information is the maximum line No. Y1 and the distance between the object A to be imaged and the image capturing position is distance L. Thus, the following equations (1) and (2) are obtained.
θ3=a tan (H÷L) (1)
(where a tan is a reciprocal of tan)
Y1=y×((θ3−θ4)÷θ1) (2)
Using equations (1) and (2), the following equation (3) is obtained.
Y1=y×((a tan (H÷L)−θ4)÷θ1) (3)
Equation (3) is rewritten as the following equation (4).
Y1×θ1÷y+θ4=a tan (H÷L) (4)
Furthermore, equation (4) is written as the following equation (5).
tan (Y1×θ1÷y+θ4)=H÷L (5)
Thus, the coordinate Y1 at the foot of the object A to be imaged and the distance L between the object A to be imaged and the image capturing apparatus 11 are calculated by the following equation (6).
L=H÷(tan (Y1×θ1÷y+θ4)) (6)
(where y is the total number of lines in an image frame).

Therefore, in order to determine the distance between the object A to be imaged and the image capturing apparatus 11, first, it is necessary to obtain the coordinate Y1 at the foot of the object A to be imaged.

The operation of the distance measurement apparatus 10A, having the aforementioned structure, according to Embodiment 1 will be described.

An image information of the first image from the image capturing apparatus 11 is stored as a reference image in the reference image storage apparatus 12. After the completion of the process of storing, the image information of the reference image already stored in the reference image storage apparatus 12 and the image information of the next image newly captured by the image capturing apparatus 11 are input to the difference image summing apparatus 13.

An absolute value of difference between each corresponding image information of the two images is added for each line of the image information of the two images. A total amount of pixel data for each of y number of lines in an image frame (y is the total number of lines in the image frame) is output from the difference image summing apparatus 13. A maximum line No. is identified as Y1 among each and every one of the respective total amounts of pixel data for each line in an image output by the first line computation unit 14. The maximum line No. has a value greater than or equal to the object determination threshold. As a result, the coordinate at the foot of the object A to be imaged in the image information can be obtained. The process of calculating the coordinate at the foot of the object A to be imaged will be described with reference to FIG. 3.

The sum of the absolute value of difference for each line is illustrated graphically (shaded area) shown on the right side in the FIGS. 3(a) to 3(c) based on the width of the object A to be imaged in a horizontal direction. Under the ideal condition that there is no presence of noise or others for causing error, the part at the lowermost position (maximum line No.) which indicates greater than or equal to 1 (object determination threshold) in each graph is the lowermost position (coordinate at the foot) of the object A to be imaged.

In the difference image summing apparatus 13, the image information of the reference image B from the reference image storage apparatus 12 shown in FIG. 3(d) and an image information of an image newly captured by the image capturing apparatus 11 shown in FIG. 3(e) are used as input. The difference image summing apparatus 13 adds the absolute value of difference between each corresponding image information of the two images for each line and outputs a total amount of pixel data for each line as the difference absolute image G shown in FIG. 3(f).

Under the condition of being greater than the object determination threshold, the first line computation unit 14 identifies the maximum line No. Y1 among the projection data T (Y) output from the difference image summing apparatus 13 for each line Y and outputs the maximum line No. Y1.

Using the output data (the maximum line No. Y1) from the first line computation unit 14 as an address, the distance table memory 15 outputs a distance data L corresponding to the maximum line No. Y1 by accessing the distance table memory 15. The distance data L is registered in the distance table memory 15.

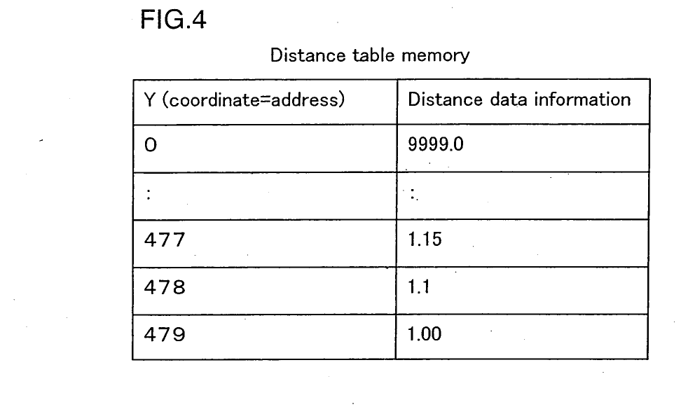

FIG. 4 is a diagram showing a structural example of a distance table in the distance table memory 15 in FIG. 1. In this case, the number of y coordinates in an image frame (y is the total number of lines in the image frame) is 480.

As shown in FIG. 4, the line No. Y and the information of the distance data which are associated with each other using equation (6) are previously calculated and registered in the distance table memory 15. The line No. Y on the left side in FIG. 4 is used as an address for the table distance memory 15. The distance data information (L) is depicted next (right) to the line No. information in FIG. 4. The distance data information (L) corresponding to the address is referenced and output. The data referenced in the distance table memory 15 changes whenever the image capturing apparatus 11, its mounting conditions (image capturing position, angle of the image capturing direction and/or image capturing area) and other systems are changed.

As described above, according to Embodiment 1, when the lowermost coordinate (maximum line No. Y1) of the object A to be imaged in the image information is detected, it is possible to detect the distance data L between the object A to be imaged and the image capturing position by performing a simple image processing. As a result, the processing speed is improved. In the case of the present invention, there is no need for two or more image capturing apparatuses as required by the conventional method or no need for matching the timing of capturing images between each image capturing apparatus. Thus, it is possible to prevent a decrease in computation accuracy. Furthermore, only one image capturing apparatus 11 is required and there is no need for a computation unit to perform a high speed processing. Thus, the cost of the apparatus can be reduced. Furthermore, the image capturing apparatus 11 with one reflex lens can realize a much cheaper system compared to a system in which the focal distance and the position of the image capturing apparatus 11 are changed in order to measure the distance to the object A to be imaged (which means that the triangular surveying method is performed using only one image capturing apparatus 11).

In Embodiment 1, the distance table memory 15 is used as a distance data obtaining section to simplify the structure. However, a computation unit which performs a computation processing of equation (6) (distance data calculation section) can be used as a distance data obtaining section.

In the difference image summing apparatus 13, the image information of the reference image stored in the reference image storage apparatus 12 and the image information of the image newly captured by the image capturing apparatus 11 are used as input images. The difference image summing apparatus 13 adds the absolute value of difference between each corresponding image information of the two images for each line of the image information of the two images and outputs a total amount of pixel data for each line. However, when it is assumed that the absolute value of difference between each corresponding image information of the two images which is less than the object determination threshold is “0” and the absolute value of difference between each corresponding image information of the two images which is greater than or equal to the object determination threshold is “1”, the absolute value of difference between each corresponding image information of the two images can be added for each line of the image information of the two images and a total amount of pixel data for each line can be output.

### Embodiment 2

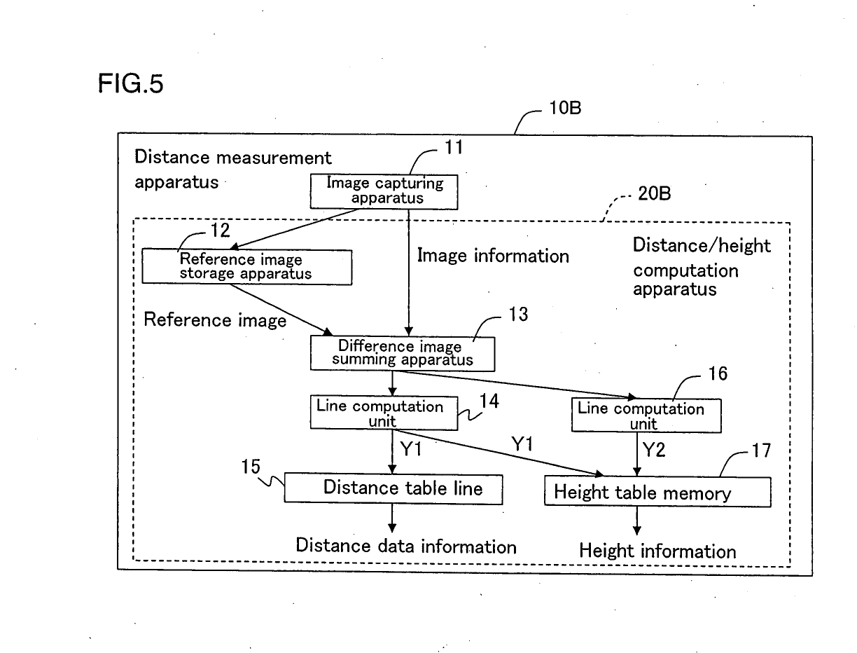

FIG. 5 is a block diagram showing a structure of a distance measurement apparatus according to Embodiment 2 of the present invention. In FIG. 5, the constituents which have the same working effect as ones shown in FIG. 1 are denoted by the same reference numerals, and description thereof will be omitted.

In FIG. 5, a distance measurement apparatus 10B according to Embodiment 2 includes an image capturing apparatus 11 which functions as an image capturing section, a reference image storage apparatus 12 which functions as a reference image storage section, a difference image summing apparatus 13 which functions as a difference image summing section, a first line computation unit 14 which functions as a first line computation section, a distance table memory 15 which functions as a distance data obtaining section, a second line computation unit 16 which functions as a second line computation section, and a height table memory 17 which functions as a height data obtaining section. A distance/height computation apparatus 20B is configured by the reference image storage apparatus 12, the difference image summing apparatus 13, the first line computation unit 14, the distance table memory 15, the second line computation unit 16 and the height table memory 17. Referring to the distance computation apparatus 20B, a distance data computation section is configured by the difference image summing apparatus 13, the first line computation unit 14 and the distance table memory 15, the second line computation unit 16 and the height table memory 17. A distance data L indicating a distance between an object A to be imaged and the image capturing position and a height data indicating a height from the ground surface to the top of the object A to be imaged are determined based on a lowermost position information (maximum line No. Y1) and an uppermost position information (minimum line No. Y2) of the object A to be imaged in an image frame, the lowermost position information being based on a difference value (absolute value of difference) between an image information of the reference image stored in a reference image storage apparatus 12 and an image information of an image newly captured by the image capturing apparatus 11.

The second line computation unit 16 receives a total amount of pixel data for each of y number of lines in an image frame (y is the total number of lines in the image frame) from the difference image summing section 13, the total amount of data relating to a y coordinate, and outputs a minimum line No. Y2 among each and every one of the respective total amounts of pixel data for each line received. The minimum line No. Y2 has a value greater than or equal to the object determination threshold.

Based on the maximum line No. Y1 output from the first line computation unit 14 and the minimum line No. Y2 output from the second line computation unit 16, the height table memory 17 outputs (identifies) a height data h which indicates a height from the ground surface to the top of an object A to be imaged. In Embodiment 2, the maximum line No. Y1 and the minimum line No. Y2 are used as an address for the height table memory 17, and a height data h corresponding to the maximum line No. Y1 and the minimum line No. Y2 is output by accessing the height distance table memory 17. The height data h is registered in height distance memory 17.

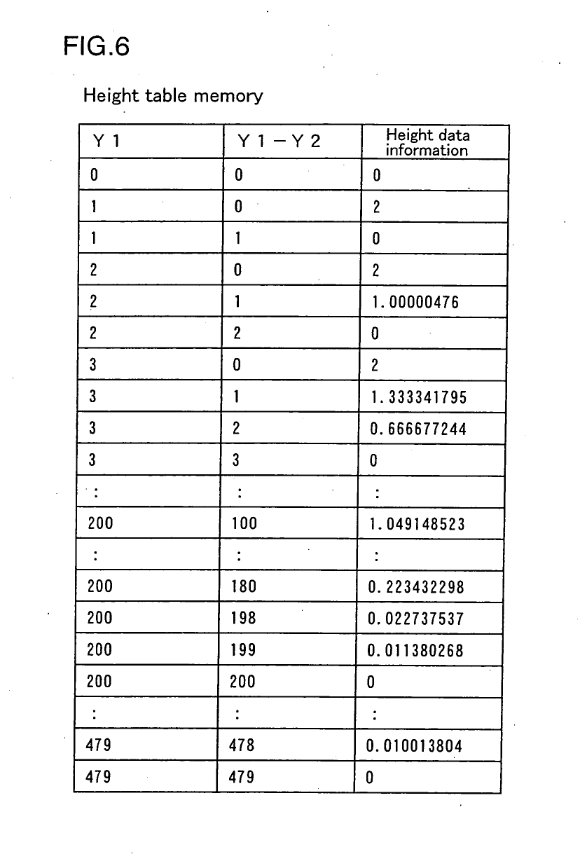

FIG. 6 is a diagram showing a structural example of the height table memory 17 in FIG. 5. In this case, the number of y coordinates in an image frame (y is the total number of lines in the image frame) is 480 (y=480).

In FIG. 6, the maximum line No. Y1, the difference between the maximum line No. Y1 and the minimum line No. Y2 (maximum line No. Y1−the minimum line No. Y2) and the height data h are associated with each other in the height table memory 17. The maximum line No. Y1 and the difference between the maximum line No. Y1 and the minimum line No. Y2 (maximum line No. Y1−the minimum line No. Y2) on the left side in FIG. 6 are used as an address for the height table memory 17. The height data h (height data information) corresponding to the address is referenced and output, the height data h being depicted next (right) to the maximum line No. Y1 and the difference between the maximum line No. Y1 and the minimum line No. Y2 (maximum line No. Y1−the minimum line No. Y2) in FIG. 6. The height data h referenced in the distance table memory 17 changes whenever the image capturing apparatus 11, its mounting conditions (image capturing position, angle of the image capturing direction and/or image capturing area) and/or other systems are changed.

As described above, according to Embodiment 2, when the lowermost coordinate Y1 and the uppermost coordinate Y2 of the object A to be imaged in the image information are detected, it is possible to easily detect the distance (distance data L) between the object A to be imaged and the image capturing position and the height (height data h) from the ground surface to the top of the object A to be imaged by performing a simple image processing. As a result, the processing speed is improved. Furthermore, in the case of the present invention, there is no need for two or more image capturing apparatuses as required by the conventional method or no need for matching the timing of capturing images between each image capturing apparatuses. Thus, it is possible to prevent a decrease in computation accuracy. Furthermore, only one image capturing apparatus 11 is required and there is no need of a computation unit to perform a high speed processing. Thus, the cost of the apparatus can be reduced. Furthermore, the image capturing apparatus with one reflex lens can realize a much cheaper system compared to a system in which the focal distance and the position of the image capturing apparatus 11 are changed in order to measure the distance to the object A to be imaged (which means that the triangular surveying method is performed using only one image capturing apparatus).

In Embodiment 2, the height table memory 17 is used as a height data obtaining section to simplify the structure. However, a computation unit which calculates a height from the ground surface to the top of the object A to be imaged by performing a computation processing using the maximum line No. Y1 and the minimum line No. Y2 can be used as a height data obtaining section.

In this case, the height data h is calculated by the computation unit using the following equation.
h=H−L×tan ((Y1−Y2)÷y×θ1+θ4)

As described above, the height table memory 17 is configured by a height table memory in which the maximum line No. Y1, the difference between the maximum line No. Y1 and the minimum line No. Y2 (the maximum line No. Y1−the minimum line No. Y2) and the height data h are associated with each other. The maximum line No. Y1 and the difference between the maximum line No. Y1 and the minimum line No. Y2 (maximum line No. Y1−the minimum line No. Y2) are used as an address for the height table memory 17, and the height data h corresponding to the maximum line No. Y1 and the difference between the maximum line No. Y1 and the minimum line No. Y2 (maximum line No. Y1−the minimum line No. Y2) is output from the height table memory 17. The height data h is previously calculated using the aforementioned equation and registered in the height table memory 17 so as to correspond to the maximum line No. Y1 and the difference between the maximum line No. Y1 and the minimum line No. Y2 (maximum line No. Y1−the minimum line No. Y2), respectively.

### Embodiment 3

The distance data computation sections in Embodiments 1 and 2 can be configured by hardware or software. In Embodiment 3, a case in which the distance data computation section in Embodiment 2 is configured by software will be described.

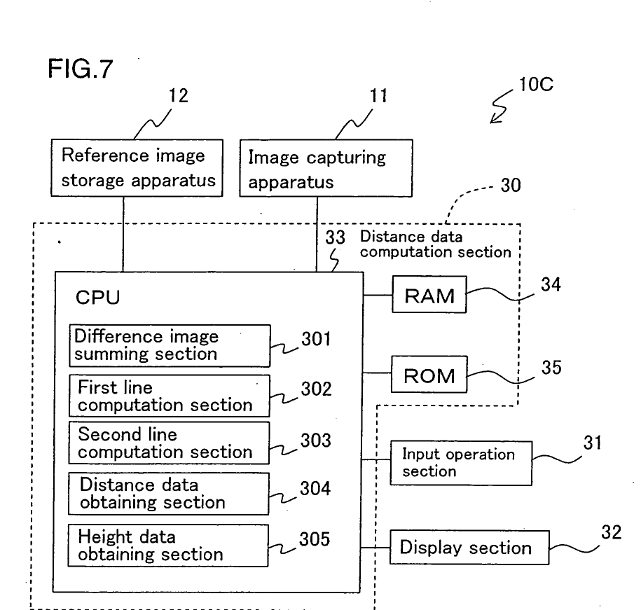

FIG. 7 shows a block diagram showing a structure of a distance measurement apparatus according to Embodiment 3 of the present invention.

In FIG. 7, other than the image capturing apparatus 11 and the reference image storage apparatus 12, the distance measurement apparatus 10C according to Embodiment 3 includes a distance data computation section 30, an operation input section 31 capable of issuing a variety of input instructions (e.g., activating or stopping the processing of distance measurement) and a display section 32 capable of displaying the display contents on a display screen in accordance with the variety of input instructions. The distance data computation section 30 includes a CPU 33 (central processing unit) as a control section which performs an entire control thereof, RAM 34 (storage section) working as a work memory when the CPU 33 is activated and a ROM 35 as a computer-readable recording medium having a distance measurement control program and a variety of data using the distance measurement control programs thereon for operating the CPU 33.

The ROM 35 can be configured by a hard disk, an optical disk, a magnetic disk and/or an IC memory. The distance measurement control program and the variety of data using the distance measurement control programs can be downloaded onto the ROM 35 from a portable optical disk, magnetic disk or IC memory, can be downloaded onto the ROM 35 from a hard disk of computer, or can be downloaded onto the ROM 35 via cable and/or wireless Internet.

The CPU 33 performs a distance data computation processing in order to obtain a distance L indicating a distance between an object A to be imaged and the image capturing position based on the lowermost position information of the object A to be imaged in an image frame, the lowermost position based on a difference value between an image information of a reference image stored in the reference image storage apparatus 12 and an image information of an image newly captured by the image capturing apparatus 11. This operation is based on the distance measurement control program and the variety of data using the distance measurement control program read into the RAM 34 from the ROM 35 and is performed after the completion of the process of storing the reference image by the reference image storage apparatus 12 which stores the image information of the image from the image capturing apparatus 11 as the reference image, for which information is known regarding an image capturing position, an angle of image capturing direction and an image capturing area.

The distance data computation section 30 includes a difference image summing section 301, a first line computation section 302, a second line computation section 303, a distance data obtaining section 304 and a height data obtaining section 305. The difference image summing section 301 adds the absolute value of difference between each corresponding image information of the two images for each line of the image information of the two images and outputs a total amount of pixel data for each line, using the image information of the reference image stored already in the reference image storage apparatus 12 and an image information of an image newly captured by the image capturing apparatus 11 as input images after the completion of the process of storing the reference image by the reference image storage apparatus 12. The first line computation unit 302 receives a total amount of pixel data for each of y number of lines in an image frame (y is the total number of lines in the image frame) from the difference image summing section 301 and identifies a maximum line No. Y1 as a lowermost position information in the image frame among each and every one of the respective total amounts of pixel data for each line, the maximum line No. Y1 having a value greater than or equal to the object determination threshold. The second line computation unit 303 receives a total amount of pixel data for each of y number of lines in an image frame (y is the total number of lines in the image frame) from the difference image summing section 301 and identifies a minimum line No. Y2 as an uppermost position information in the image frame among each and every one of the respective total amounts of pixel data for each line, the minimum line No. Y2 having a value greater than or equal to the object determination threshold. The distance data obtaining section 304 obtains a distance data L indicating a distance between the object A to be imaged on the ground and the image capturing position of the image capturing apparatus 11 based on the maximum line No. Y1 from the first line computation section 302. The height data obtaining section 305 obtains a height data indicating a height from the ground surface to the top of the object A to be imaged using the maximum line No. Y1 and the minimum line No. Y2.

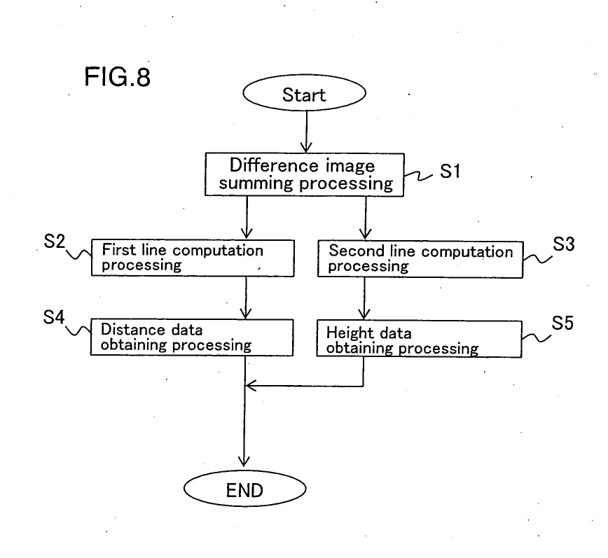

With the configuration described above, in the distance data computation processing, as shown in FIG. 8, in step S1 of the difference image summing processing, the absolute value of difference between each corresponding image information of the two images for each line is added and the total amount of pixel data for each line is output, using the image information of the reference image stored already in the reference image storage apparatus 12 and an image information of an image newly captured by the image capturing apparatus 11 as input images

In step S2 of the first line computation processing, a total amount of pixel data for each of y number of lines in an image frame (y is the total number of lines in the image frame) obtained from the difference image summing processing is received. A maximum line No. Y1 is identified as a lowermost position information (foot information) of the object A to be imaged in the image frame among each and every one of the respective total amounts of pixel data for each line received. The maximum line No. Y1 has a value greater than or equal to the object determination threshold.

In step S3 of the second line computation processing, a total amount of pixel data for each of y number of lines in an image frame (y is the total number of lines in the image frame) obtained from the difference image summing processing is received. A minimum line No. Y2 is identified as an uppermost position information (head information) of the object A to be imaged in the image frame among each and every one of the respective total amounts of pixel data for each line received. The minimum line No. Y2 has a value greater than or equal to the object determination threshold.

In step S4 of the distance data obtaining processing, a distance data L indicating a distance between the object A to be imaged on the ground surface and the image capturing position of the image capturing apparatus 11 is obtained, based on the maximum line No. Y1 obtained from the first line computation processing.

In step S5 of the height data obtaining processing, a height data indicating the height from the ground surface in a horizontal direction to the top of the object A to be imaged is determined using the maximum line No. Y1 and the minimum line No. Y2 obtained from the first line computation processing and the second line computation processing.

In the distance data obtaining processing and the height data obtaining processing, similar to the cases in Embodiments 1 and 2, the distance data and the height data can be determined using the aforementioned equations or can be determined using the distance table memory or the height table memory.

Similar to the cases in Embodiments 1 and 2, this case does not require two or more image capturing apparatuses but one image capturing apparatus 11. Even when there is no presence of an object to be imaged whose size is known, the distance L between the object A to be imaged and the image capturing apparatus 11 can be detected by performing a simple image processing.

Although a particular description is not made in Embodiments 1 to 3, an electronic device (e.g., a vacuum clear randomly running in a room and/or a surveillance camera) can be obtained, the electronic device performing a risk avoidance processing when a distance between the object A to be imaged and the image capturing apparatus 11 which is obtained by the distance measurement apparatuses 10A, 10B and/or 10C in Embodiments 1 to 3 is within a predetermined range, having the distance measurement apparatuses 10A, 10B and/or 10C mounted thereon.

The distance measurement apparatuses 10A, 10B and 10C in Embodiments 1, 2 and 3 are mounted on a vehicle and the like to be used as a risk avoidance processing apparatus for an electronic device. The distance measurement apparatuses 10A, 10B and 10C in Embodiments 1, 2 and 3 can be used when a risk avoidance processing (e.g., issuing a warning or causing the vehicle to change lanes in a moving direction or to stop) is performed when the distance to the object A to be imaged is within a predetermined risky range.

As described above, the present invention is exemplified by the use of its preferred Embodiments 1 to 3. However, the present invention should not be interpreted solely based on Embodiments 1 to 3 described above. It is understood that the scope of the present invention should be interpreted solely based on the claims. It is also understood that those skilled in the art can implement equivalent scope of technology, based on the description of the present invention and common knowledge from the description of the detailed preferred Embodiments 1 to 3 of the present invention. Furthermore, it is understood that any patent, any patent application and any references cited in the present specification should be incorporated by reference in the present specification in the same manner as the contents are specifically described therein.

### INDUSTRIAL APPLICABILITY

In the field of: a distance measurement apparatus capable of determining a distance from the apparatus to an object to be imaged and a size of the object to be imaged (the height from ground surface), the distance and size being determined based on an image, the size of the image varying depending on the distance to be imaged from the apparatus; an electronic device (e.g. a vacuum clear running randomly in a room or a surveillance camera) having the distance measurement apparatus mounted thereon; a distance measurement method using the distance measurement apparatus; a distance measurement control program for causing a computer to execute each step of the distance measurement method; and a computer-readable medium for having the distance measurement control program recorded thereon, the present invention can detect a distance L between an object A to be imaged and an image capturing position and a height h from the ground surface to the top of the object A to be imaged by performing a simple image processing. As a result, the processing speed is improved. Furthermore, there is no need for two or more image capturing apparatuses as required by the conventional method or no need for matching the timing of capturing images between each image capturing apparatuses. Thus, it is possible to prevent a decrease in computation accuracy. Furthermore, only one image capturing apparatus is required and there is no need for a computation unit to perform a high speed processing. Thus, the cost of the apparatus can be reduced.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A distance measurement apparatus comprising:
an image capturing section for capturing an image of an object to be imaged, for which information is known regarding an image capturing position, an angle of image capturing direction and an image capturing area;
a reference image storage section for receiving the image from the image capturing section and storing an image information of the image as a reference image; and
a distance data computation section for determining a distance data L, the distance data L indicating a distance between the object to be imaged and the image capturing position, the determination being based on a lowermost position information of the object to be imaged in an image frame, the lowermost position information being based on a difference value between the image information of the reference image stored in the reference image storage section and an image information of an image newly captured by the image capturing section.

2. A distance measurement apparatus according to claim 1, wherein the distance data computation section includes:
after the completion of the process of storing the reference image by the reference image storage section, a difference image summing section for adding an absolute value of difference between each corresponding image information of the two images for each of a plurality of lines and outputting a total amount of pixel data for each line, using the image information of the reference image stored in the reference image storage section and the image information of the image newly captured by the image capturing section as input images;
a first line computation section for receiving a total amount of pixel data for each of a total number of lines y in the image frame obtained by the difference image summing section, and identifying a maximum line No. Y1 as the lowermost position information among each and every one of the respective total amounts of pixel data for each line received, the maximum line No. Y1 having a value greater than or equal to an object determination threshold; and
a distance data obtaining section for obtaining a distance data L indicating a distance between the object to be imaged on the ground and the image capturing position, the obtaining being based on the maximum line No. Y1 identified by the first line computation section.

3. A distance measurement apparatus according to claim 1, wherein the information of the image capturing position is a height H from the ground surface to the image capturing section, the information of the angle of the image capturing direction is an angle θ2 between a line normal to a light receiving plane of the image capturing section and the ground surface, and the information of the image capturing area is a viewing angle θ1 in the longitudinal direction of the image capturing section, and an angle θ4 between the direction of an uppermost angle of the viewing angle θ1 and the ground surface.

4. A distance measurement apparatus according to claim 2, wherein the distance data obtaining section calculates the distance data L using the equation:
L=H÷(tan (Y1×θ1÷y+θ4))
(where θ1 is a viewing angle in the longitudinal direction of the image capturing apparatus and θ4 is a viewing angle between the direction of uppermost angle of the viewing angle θ1 and the ground surface in a horizontal direction).

5. A distance measurement apparatus according to claim 2, wherein the distance data obtaining section is configured by a distance table memory in which the maximum line No. Y1 and the distance data L are associated with each other, and wherein the distance data obtaining section uses the maximum line No. Y1 as an address for the distance table memory and outputs the distance data L corresponding to the address.

6. A distance measurement apparatus according to claim 5, wherein the distance table L is previously calculated and registered in the distance table memory so as to correspond to the maximum line No. Y1, the distance table L being calculated using the equation:
L=H÷(tan (Y1×θ1÷y+θ4))
(where θ1 is a viewing angle in the longitudinal direction of the image capturing apparatus and θ4 is a viewing angle between the direction of uppermost angle of the viewing angle θ1 and the ground surface in a horizontal direction).

7. A distance measurement apparatus according to claim 2, wherein the distance data computation section further includes:
a second line computation section for receiving a total amount of pixel data for each of total number of lines y in an image frame from the difference image summing section, and identifying, among each and every one of the respective total amounts of pixel data for each line received, a minimum line No. Y2 as an uppermost position information of the object to be imaged in the image frame, the minimum line No. Y2 having a value greater than or equal to an object determination threshold; and
a height data obtaining section for obtaining a height data indicating a height from the ground surface to the top of an object to be imaged using the maximum line No. Y1 and the minimum line No. Y2.

8. A distance measurement apparatus according to claim 7, wherein the height data obtaining section calculates the height data h using the equation:
h=H−L×tan ((Y1−Y2)÷y×θ1+θ4)
(where θ1 is a viewing angle in the longitudinal direction of the image capturing apparatus and θ4 is a viewing angle between the direction of uppermost angle of the viewing angle θ1 and the ground surface in a horizontal direction).

9. A distance measurement apparatus according to claim 7, wherein the height data obtaining section is configured by a height table memory in which the maximum line No. Y1, the difference between the maximum line No. Y1 and the minimum line No. Y2 (maximum line No. Y1−the minimum line No. Y2) and the height data h are associated with each other, and wherein the height data obtaining section uses the maximum line No. Y1 and the difference between the maximum line No. Y1 and the minimum line No. Y2 (maximum line No. Y1−the minimum line No. Y2) as an address for the height table memory and outputs the height data h corresponding to the address.

10. A distance measurement apparatus according to claim 9, wherein the height data h is previously calculated and registered in the height table memory so as to correspond to the maximum line No. Y1 and the difference between the maximum line No. Y1 and the minimum line No. Y2 (maximum line No. Y1−the minimum line No. Y2), the height data h being calculated using the equation:
h=H−L×tan ((Y1−Y2)÷y×θ1+θ4)
(where θ1 is a viewing angle in the longitudinal direction of the image capturing apparatus and θ4 is a viewing angle between the direction of uppermost angle of the viewing angle θ1 and the ground surface in a horizontal direction).

11. A distance measurement apparatus according to claim 2, wherein the difference image summing section outputs a total amount of pixel data for each of a total number of lines y in an image frame, using the image information of the reference image stored in the reference image storage section and the image information of the image newly captured by the image capturing section as input images when the absolute value of difference between each corresponding image information of the two images which is less than the object determination threshold is “0” and the absolute value of difference between each corresponding image information of the two images which is greater than or equal to the object determination threshold is “1”.

12. An electronic device, having the distance measurement apparatus according to claim 1 mounted thereon, for performing a risk avoidance processing when the distance between the distance measurement apparatus and an object to be imaged obtained by the distance measurement apparatus is within a predetermined range.

13. A distance measurement method, comprising:
after the completion of the process of storing a reference image by a reference image storage section which stores an image information of an image from the image capturing section as the reference image, for which information is known regarding an image capturing position, an angle of image capturing direction and an image capturing area, a distance data computation step of determining a distance data L, the distance data L indicating a distance between the object to be imaged and the image capturing position, the determination is based on a lowermost position information of the object to be imaged in an image frame, the lowermost position information being based on a difference value between the image information of the reference image stored in the reference image storage section and an image information of an image newly captured by the image capturing section.

14. A distance measurement method according to claim 13, wherein the distance data computation step includes:
a difference image summing step of adding an absolute value of difference between each corresponding image information of the two images for each of a plurality of lines and outputting a total amount of pixel data for each line, the summing step using the image information of the reference image stored in the reference image storage section and the image information of the image newly captured by the image capturing section as input images;
a first line computation step of receiving a total amount of pixel data for each of a total number of line y in an image frame obtained from the difference image summing step, and identifying a maximum line No. Y1 as a lowermost position information among each and every one of the respective total amounts of pixel data for each line received, the maximum line No. Y1 having a value greater than or equal to an object determination threshold; and
a distance data obtaining step of obtaining a distance data L, the distance data L indicating a distance between the object to be imaged on the ground and the image capturing position, the distance data obtaining step being based on the maximum line No. Y1 identified from the first line computation step.

15. A distance measurement method according to claim 14, wherein the distance data computation step further includes:
a second line computation step of receiving a total amount of pixel data for each of a total number of lines y in an image frame obtained from the difference image summing step, and identifying, among each and every one of the respective total amounts of pixel data for each line received, a minimum line No. Y2 as an uppermost position information of the object to be imaged in the image frame, the minimum line No. Y2 having a value greater than or equal to an object determination threshold; and
a height data obtaining step of determining a height from the ground surface to the top of an object to be imaged using the maximum line No. Y1 and the minimum line No. Y2.

16. A distance measurement control program for causing a computer to execute each step of the distance measurement method according to claim 13.

17. A computer-readable medium having the distance measurement control program according to claim 16 recorded thereon.
